(19) United States
(12) Patent Application Publication
(10) Pub. No.: US 2013/0002927 A1
(43) Pub. Date: Jan. 3, 2013

(54) PORTABLE VIDEO VIEWFINDERS WITH MULTIPLE MODULATED LIGHT SOURCES

(76) Inventor: Dale Christopher Backus, Apex, NC (US)

(21) Appl. No.: 13/540,130

(22) Filed: Jul. 2, 2012

Related U.S. Application Data
(60) Provisional application No. 61/503,294, filed on Jun. 30, 2011.

(51) Int. Cl. H04N 5/225

(52) U.S. Cl. 348/333.08; 348/E05.025

(57) ABSTRACT

A viewfinder apparatus includes a plurality of solid state light emitters, a plurality of electro-optic modulators corresponding to ones of the plurality of solid state light emitters, and a plurality of light diffusion layers. Each light diffusion layer is disposed between one of the plurality of the electro-optic modulators and a respective one of the plurality of solid state light emitters. A light combiner, such as a dichroic prism, is configured to form color images by combining modulated luminous flux from the electro-optic modulators. At least one optical element is positioned relative to the light combiner such that the electro-optic modulators become the focal point of an eye of a user of the viewfinder apparatus. As such, the eye of a user is focused on the color images formed by the light combiner.

### RELATED APPLICATION

This application claims the benefit of and priority to U.S. Provisional Patent Application No. 61/503,294, filed on Jun. 30, 2011, the contents of which are incorporated herein by reference in its entirety.

### FIELD OF THE INVENTION

The present invention relates generally to viewfinders and, more particularly, to high resolution portable electronic viewfinders.

### BACKGROUND

FIG. 1 shows typical 3-LCD (liquid crystal device) projection system 100 for use in a video projector system. Further details of such projectors are provided by U.S. Pat. Nos. 6,957,892, 7,204,594, 7,742,028, 7,545,456, 7,443,565 and 7,714,902 assigned to Seiko Epson Corporation, all of which are incorporated by reference herein in their entireties.

The 3-LCD system 100 begins with light emitted from a single white lamp 101. The white light is then divided into its three primary colors, red, green and blue, via dichroic mirrors. Each individual light path is funneled through its corresponding grayscale LCD 102. Each LCD 102 controls the pattern of red, green or blue light passing through it and, therefore, creates a unique image using that specific wavelength of light. The red, green and blue images produced by the three different LCDs are then combined using a dichroic “x-cube” prism 103. The result is a full color image that may be projected onto a surface, such as a projection screen 105, utilizing additional optics 104 after the dichroic “x-cube” prism 103.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

In environments, such as movie and television filming, a true color and high definition representation of what has been or is being filmed is highly desirable and advantageous. Among its several aspects, the present invention addresses improved viewfinder technology for providing high definition resolution in a display device small enough to fit into a typical broadcast camera viewfinder.

According to some embodiments of the present invention, a viewfinder apparatus includes a plurality of solid state light emitters, a plurality of electro-optic modulators corresponding to ones of the plurality of solid state light emitters, and a plurality of light diffusion layers. Each light diffusion layer is disposed between one of the plurality of the electro-optic modulators and a respective one of the plurality of solid state light emitters. A light combiner, such as a dichroic prism, is configured to form color images by combining modulated luminous flux (i.e., light) from the electro-optic modulators. At least one optical element is positioned relative to the light combiner such that the electro-optic modulators become the focal point of an eye of a user of the viewfinder apparatus. As such, the eye of a user is focused on the color images formed by the light combiner.

Each of the plurality of solid state light emitters is configured to emit luminous flux corresponding to a different dominant wavelength of light. In some embodiments of the present invention, the plurality of solid state light emitters comprise a first light emitter that is configured to emit light including a first dominant wavelength, a second light emitter that is configured to emit light including a second dominant wavelength, and a third light emitter that is configured to emit light including a third dominant wavelength, wherein the first dominant wavelength, the second dominant wavelength and the third dominant wavelength are each different from the other. For example, the first dominant wavelength may correspond to a blue color, the second dominant wavelength may correspond to a red color, and the third dominant wavelength may correspond to a green color. In some embodiments of the present invention, each of the light emitters emits substantially parallel luminous flux.

Each electro-optic modulator is configured to modulate the luminous flux coming from a respective one of the plurality of solid state light emitters in accordance with image information received from a camera with which the viewfinder apparatus is utilized. In some embodiments of the present invention, the electro-optic modulators are monochrome liquid crystal devices (LCDs).

Viewfinders according to embodiments of the present invention are advantageous over conventional viewfinders utilizing a single white light source because white light sources may have difficulty in creating a broad spectrum of light fully populated in all visible wavelengths. In contrast, the use of separate red, green, and blue light sources ensures that a broad spectrum of light fully populated in substantially all visible wavelengths may be obtained.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 illustrates a prior art 3-LCD projection arrangement.

FIG. 2 illustrates 3-LCD viewfinder optics in accordance with some embodiments of the present invention.

FIG. 3A is a front perspective view of a viewfinder apparatus incorporating the optics of FIG. 2, according to some embodiments of the present invention.

FIG. 3B is a rear perspective view of the viewfinder apparatus of FIG. 3A.

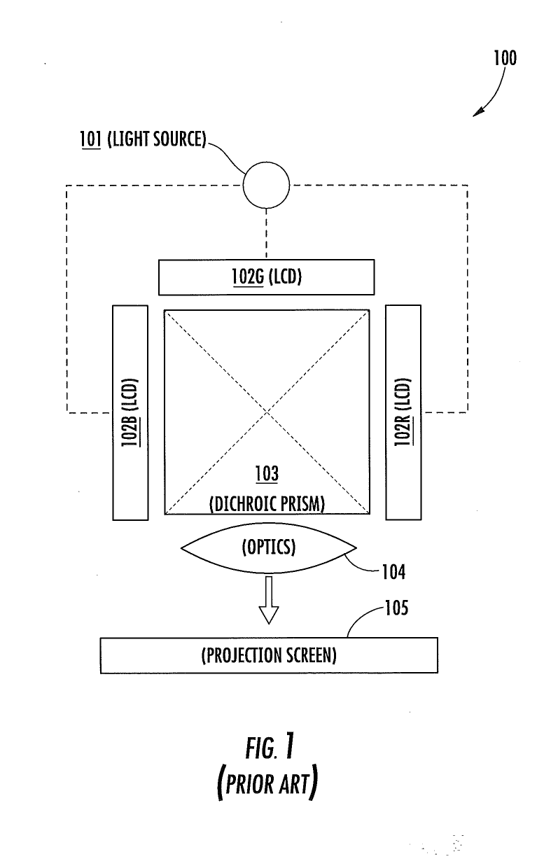

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. Features described with respect to one figure or embodiment can be associated with another embodiment of figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

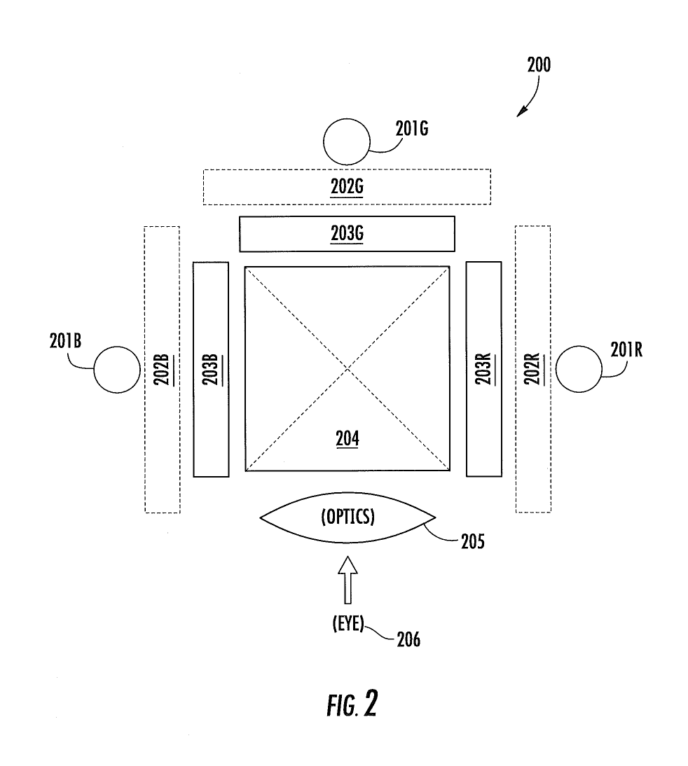

Embodiments of the present invention advantageously adapt a 3-LCD optics into high resolution portable electronic viewfinders. Referring to FIG. 2, exemplary viewfinder optics 200 in accordance with embodiments of the present invention are illustrated. To save space and power, separate red, green and blue light sources 201_{R}, 201_{G}, 201_{B} are employed. For example, in some embodiments of the present invention, light sources 201_{R}, 201_{G}, 201_{B} are solid state light emitters, such as light emitting diodes (LEDs) that emit light having a dominant wavelength. In some embodiments, each solid state light emitter 201 _{R}, 201_{G}, 201_{B} may emit light corresponding to a color, such as red, green or blue. As such, each solid state light emitter 201_{R}, 201_{G}, 201_{B} may emit light (luminous flux) corresponding to a different dominant wavelength.

Diffused “backlight” layers 202_{R}, 202_{G}, 202_{B} are added between each LCD 203_{R}, 203_{G}, 203_{B} and its respective light source 201_{R}, 201_{G}, 201_{B}. Each diffusion layer 202_{R}, 202_{G}, 202_{B} is configured to scatter light passing therethrough through a range of directions such that a viewer located on an opposite side of one of the diffusion layers 202_{R}, 202_{G}, 202_{B} from a respective light source 201_{R}, 201_{G}, 201_{B} can see light originating from the whole area of the respective diffusion layer. This arrangement advantageously allows the individual LCDs to function more like traditional color LCDs found in laptops, televisions, and the like, yet still employ the combination of images produced by three LCDs into a full color image by a light combiner 204, such as a dichroic x-cube prism.

The LCDs 203_{R}, 203_{G}, 203_{B} form color images through modulation of luminous flux from respective light sources 201_{R}, 201_{G}, 201B in accordance with image information from a camera. Each LCD 203_{R}, 203_{G}, 203_{B} is illuminated by a respective light source 201_{R}, 201_{G}, 201_{B}. The LCDs 203_{R}, 203_{G}, 203_{B} are each configured by hermetically filling an electro-optic liquid crystal substance between a pair of transparent glass substrates. With, for example, a polysilicon TFT (Thin-Film Transistor) serving as a switching element, the LCDs 203_{R}, 203_{G}, 203_{B} modulate the light from the respective light sources 201_{R}, 201_{G}, 201_{B}. Such modulation is performed based on an image signal from a camera.

In some embodiments of the present invention, the light combiner 204 is a dichroic x-cube prism 204, which is an optical element for forming color images through the combination of optical images. A dichroic x-cube prism has a generally square configuration when viewed from above, and is made of four right-angle prisms attached together. The substantially-X-shaped interfaces of the right-angle prisms may be formed, for example, with dielectric multilayer films. The dielectric multilayer film formed on one of the substantially-X-shaped interfaces reflects the red color light, and the dielectric multilayer film formed on the other interface reflects the blue color light. By use of such dielectric multilayer films, the red and blue lights are both bent in direction, and aligned with the heading direction of the green light so that three color lights are combined together. However, a light combiner 204 having various configurations may be utilized in accordance with embodiments of the present invention. Moreover, a light combiner 204 in accordance with embodiments of the present invention may have any number of prisms or elements (e.g., less than four and more than four).

In use, a viewer, as represented by eye 206 looks through optics 205. Optics 205 include one or more optical elements (e.g., lenses) arranged to focus on images produced by the LCDs 203_{R}, 203_{G}, 203_{B} and such that the LCDs 203_{R}, 203_{G}, 203_{B} become the focal point for the eye. This arrangement allows the operator to see a full color image by looking directly into the 3-LCD cube system rather than looking at a surface or screen on which the 3-LCD system is projecting its image.

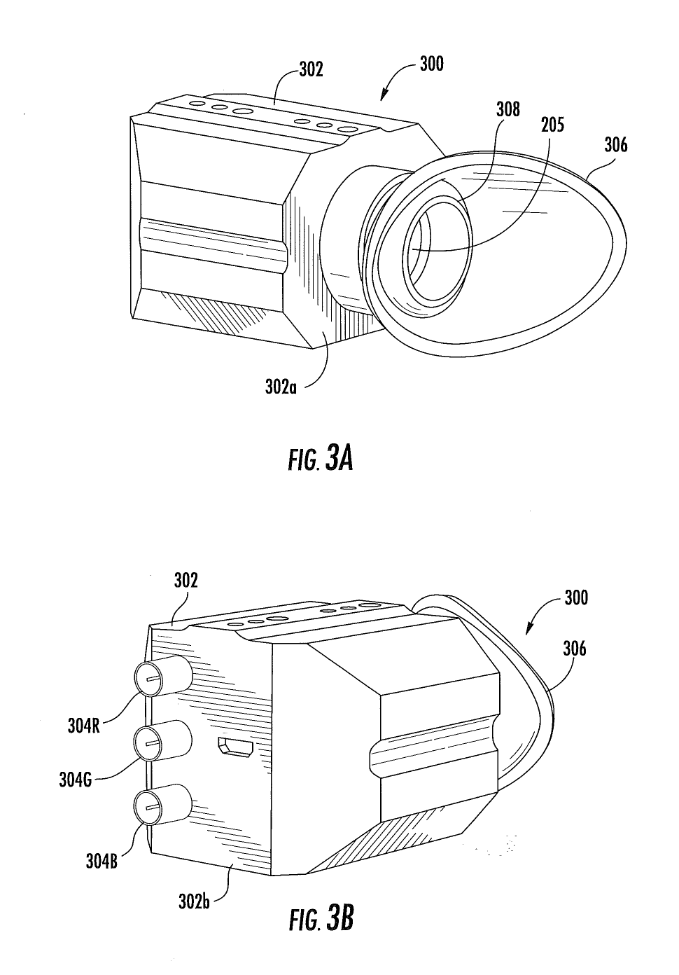

The viewfinder optics 200 may suitably be employed in a viewfinder 300 shown in FIGS. 3A-3B to implement a high resolution (HD) viewfinder apparatus for digital cinema or digital broadcast cameras. The illustrated viewfinder apparatus 300 includes a housing 302 within which the optics of FIG. 2 are housed. The housing 302 includes opposite front and rear end portions 302a, 302b. A generally cylindrical barrel 308 extends outwardly from the housing front end portion 302a, as illustrated. Barrel 308 houses optics 205 (FIG. 2), such as one or more optical elements, configured such that the three electro-optic modulators become the focal point for an eye of a user of the viewfinder optical apparatus in order to focus on the color images formed by the dichroic prism.

To make eye positioning with the viewfinder 300 more comfortable and to help block out stray light, an eye cup 306, formed from resilient material such as rubber, is connected to the barrel 308, as illustrated. Video input taps 304_{R}, 304_{G}, 304_{B} extend outwardly from the housing rear end portion 302b, as illustrated. Video input taps 304_{R}, 304_{G}, 304_{B} allow the viewfinder optics 200 to receive image information in the form of respective red, green, blue signals from a digital cinema or digital broadcast camera, as would be understood by those skilled in the art of the present invention.

A viewfinder apparatus, according to embodiments of the present invention, may be about the size of a viewfinder found on a large shoulder-mounted broadcast camera, although other sizes are possible, as well. Embodiments of the present invention advantageously provide full high definition resolution (1080p) in a display device small enough to fit into a typical broadcast camera's viewfinder.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A viewfinder apparatus comprising:
a plurality of solid state light emitters, each of the plurality of solid state light emitters configured to emit luminous flux corresponding to a different dominant wavelength of light;
a plurality of electro-optic modulators corresponding to ones of the plurality of solid state light emitters, each electro-optic modulator configured to modulate the luminous flux coming from a respective one of the plurality of solid state light emitters in accordance with image information received from a camera; and
a plurality of light diffusion layers, each of which is disposed between one of the plurality of the electro-optic modulators and a respective one of the plurality of solid state light emitters.

2. The viewfinder apparatus of claim 1, wherein the plurality of solid state light emitters comprise a first light emitter that is configured to emit light including a first dominant wavelength, a second light emitter that is configured to emit light including a second dominant wavelength, and a third light emitter that is configured to emit light including a third dominant wavelength, and wherein the first dominant wavelength, the second dominant wavelength and the third dominant wavelength are each different from the other.

3. The viewfinder apparatus of claim 2, wherein the first dominant wavelength corresponds to a blue color, wherein the second dominant wavelength corresponds to a red color, and wherein the third dominant wavelength corresponds to a green color.

4. The viewfinder apparatus of claim 1, further comprising a light combiner that is configured to receive the modulated luminous flux from the plurality of electro-optic modulators and transmit a combined modulated luminous flux that corresponds to a color image.

5. The viewfinder apparatus of claim 4, wherein the light combiner comprises a dichroic prism.

6. The viewfinder apparatus of claim 4, further comprising at least one optical element arranged to focus color images formed by the light combiner.

7. The viewfinder apparatus of claim 6, wherein the at least one optical element is configured such that the plurality of electro-optic modulators are the focal point for an eye of a user of the viewfinder apparatus.

8. The viewfinder apparatus of claim 1, wherein each of the plurality of solid state light emitters emits substantially parallel luminous flux.

9. The viewfinder apparatus of claim 1, wherein the plurality of electro-optic modulators comprise monochrome liquid crystal devices (LCDs).

10. The viewfinder apparatus of claim 5, wherein the dichroic prism is a dichroic x-cube prism.

11. The use of the viewfinder apparatus of claim 1 in a viewfinder-style video viewing device.

12. A viewfinder apparatus comprising:
three solid state light emitters, each light emitter configured to emit luminous flux corresponding to a different dominant wavelength of light;
three electro-optic modulators, each electro-optic modulator configured to modulate the luminous flux coming from a respective one of the three light emitters in accordance with image information received from a camera;
three light diffusion layers each of which is disposed between one of the three electro-optic modulators and a respective one of the light emitters;
a light combiner that is configured to receive the modulated luminous flux from the electro-optic modulators and transmit a combined modulated luminous flux that corresponds to a color image; and
at least one optical element configured such that the three electro-optic modulators are the focal point for an eye of a user of the viewfinder apparatus.

13. The viewfinder apparatus of claim 12, wherein the three solid state light emitters comprise a first light emitter that is configured to emit light including a first dominant wavelength, a second light emitter that is configured to emit light including a second dominant wavelength, and a third light emitter that is configured to emit light including a third dominant wavelength, wherein the first dominant wavelength corresponds to a blue color, wherein the second dominant wavelength corresponds to a red color, and wherein the third dominant wavelength corresponds to a green color.

14. The viewfinder apparatus of claim 12, wherein each light emitter emits substantially parallel luminous flux.

15. The viewfinder apparatus of claim 12, wherein the electro-optic modulators comprise monochrome liquid crystal devices (LCDs).

16. The viewfinder apparatus of claim 12, wherein the light combiner comprises a dichroic prism.

17. The viewfinder apparatus of claim 16, wherein the dichroic prism is a dichroic x-cube prism.

18. The use of the viewfinder apparatus of claim 12 in a viewfinder-style video viewing device.
